(19) United States
(12) Patent Application Publication
(10) Pub. No.: US 2021/0275942 A1
(43) Pub. Date: Sep. 9, 2021

(54) Combinations of Containers and Purifying Materials Used in the Purification of Liquids

(71) Applicants: James D. Stryker, Pittstown, NJ (US); George E. Hicks, Elizabeth, IN (US); Neal Williams, New Albany, IN (US)

(72) Inventors: James D. Stryker, Pittstown, NJ (US); George E. Hicks, Elizabeth, IN (US); Neal Williams, New Albany, IN (US)

(21) Appl. No.: 17/183,698

(22) Filed: Feb. 24, 2021

Related U.S. Application Data
(60) Provisional application No. 62/982,405, filed on Feb. 27, 2020.

(51) Int. Cl. B01D 15/08; B01J 20/10

(52) U.S. Cl. CPC B01D 15/08; B01J 20/10

(57) ABSTRACT

A combination for purifying a liquid, such as used cooking oil, unrefined edible oil, biodiesel fuel, rendered fat, or dielectric fluids comprising a container comprising a holding portion having at least one wall portion and at least one portion that is designed to fail structurally upon heating of the liquid, such as at least one cap portion, which is connected detachably to the holding portion. The combination also comprises at least one purifying material, such as an adsorbent powder, contained in the holding portion of the container. Upon contact of the container with the liquid and heating of the liquid, at least one of the at least one portion(s) that is designed to fail structurally provides at least one opening in the container, whereby the liquid is contacted by the at least one purifying material, and the liquid is purified.

This application claims priority based on Provisional Application Ser. No. 62/982,405, filed Feb. 27, 2020, the contents of which are incorporated by reference in their entirety.

This invention relates to the purification of liquids, and in particular edible oils such as used cooking oil and unrefined edible oils, as well as biodiesel fuel, rendered fats, and dielectric fluids. More particularly, this invention relates to the purification of liquids such as those hereinabove described, by contacting the liquid with a container that contains at least one purifying material, whereupon heating of the liquid into which such container is placed, the container is opened, whereby the at least one purifying material contacts the liquid, and whereby the liquid is purified.

Purifying materials, such as adsorbent materials in the form of powders, such as, for example, magnesium silicate, have been used to purify liquids such as edible oils, including used cooking oil and unrefined edible oils, biodiesel fuel, and dielectric fluids, whereby the adsorbent material removes impurities from such liquids. During the purification process, the liquids may be purified at elevated temperatures.

For example, U.S. Pat. Nos. 4,681,768; 5,597,600; and 6,368,648 disclose the use of magnesium silicate powder, either alone or in combination with other purifying materials, such as alkali materials, to remove impurities, such as free fatty acids and oxidized fatty acids, from used cooking oils. U.S. Pat. Nos. 6,312,598 and 6,482,326 disclose the purification of used cooking oils by passing the used cooking oil through a filter envelope that includes a filter pad impregnated with magnesium silicate powder.

U.S. Pat. No. 9,295,810 discloses the purification of unrefined edible oils and fats with magnesium silicate powder, either alone or in combination with organic acids, in order to remove impurities such as phosphorus-containing compounds, soap, chlorophyll, metals, and sterol glucosides from the unrefined edible oil or fat.

U.S. Pat. No. 10,563,150 discloses then purification of rendered fats with magnesium silicate powder, either alone or in combination with at least one acid, in order to remove impurities such as polyethylene, phosphorus-containing compounds, chlorophyll, metals, soap, sterol glucosides, water, and free fatty acids.

U.S. Pat. No. 7,635,398 discloses the purification of biodiesel fuel in order to remove impurities such as soap, unreacted catalyst, sulfur, phosphorus, calcium, iron, monoglycerides, diglycerides, polymeric triglycerides, acidic compounds, glycerin, chlorophyll, water, sediment, and methanol from the biodiesel fuel.

Although adsorbent powders, such as magnesium silicate powder, remove impurities from liquids such as used cooking oil, unrefined edible oils, biodiesel fuel, rendered fats, and dielectric fluids successfully, such powders may form dust, which may lead to undesired contact with and/or inadvertent inhalation of such dust when such adsorbent materials are added to the liquids to be purified.

It therefore is an object of the present invention to provide a means and a method of purifying a liquid with a purifying agent such as an adsorbent powder, whereby contact with dust is minimized or eliminated.

In accordance with an aspect of the present invention, there is provided a combination for purifying a liquid. The combination comprises a container comprising a holding portion having at least one wall portion, and at least one portion that is designed to fail structurally upon heating of the liquid. The combination also comprises at least one purifying material contained in the holding portion of the container. Upon contact of the container with the liquid and heating of the liquid, at least one of the least one portion(s) that is designed to fail structurally upon heating of the liquid provides at least one opening in the container, whereby the liquid is contacted by the at least one purifying material, and whereby the liquid is purified.

In a non-limiting embodiment, the at least one purifying material is at least one adsorbent material.

In a non-limiting embodiment, the at least one adsorbent material is selected from the group consisting of magnesium silicate (including both natural and synthetic magnesium silicate), magnesium aluminum silicate, calcium silicate, sodium silicates, activated carbon, silica gel, magnesium phosphate, metal hydroxides, metal oxides, metal carbonates, sodium sesquicarbonate, metal silicates, bleaching clays, bleaching earths, bentonite clay, alumina, and mixtures thereof.

In a non-limiting embodiment, the at least one adsorbent material comprises magnesium silicate.

In one non-limiting embodiment, the magnesium silicate has the following properties:

| | |
|---|---|
| % MgO | 15% min. (ignited basis) |
| % SiO₂ | 67% min. (ignited basis) |
| Soluble salts | 3% max. |
| Mole ratio MgO:SiO₂ | 1:1.36 to 1:3.82 |

In another non-limiting embodiment, the magnesium silicate is an amorphous, hydrated, precipitated, synthetic magnesium silicate having a surface area of at least 100 square meters per gram. In another non-limiting embodiment, the magnesium silicate has a surface area from about 300 square meters per grain to about 800 square meters per gram. In yet another non-limiting embodiment, the magnesium silicate has a surface area from about 400 square meters per gram to about 600 square meters per gram. In addition, such magnesium silicate may be employed as coarse particles, with at least 75%, and preferably at least 85% of the particles having a particle size which is greater than 400 mesh, and with no more than 15%, and preferably no more than 5%, all by weight, having a particle size greater than 40 mesh. In most cases, the average particle size of the magnesium silicate employed in accordance with the present invention is in the order of but not limited to 20-175 microns. It is to be understood, however, that the magnesium silicate may have a particle size different than the sizes mentioned hereinabove.

In addition, the magnesium silicate which is employed in accordance with a non-limiting embodiment of the present invention generally has a bulk density in the order of from 15-35 lbs./cu. ft., a pH of 3-10.8 (5% water suspension) and a mole ratio of MgO to SiO₂ of 1:1.0 to 1:4.0.

The following is a specification and typical value for a magnesium silicate which is employed in accordance with a non-limiting embodiment of the present invention.

| Parameter | Specification | Typical Value |
|---|---|---|
| Mole Ratio MgO:SiO₂ | 1:1.0 to 1:4.0 | 1:2.60 |
| pH of 5% Water Suspension | 8.0 to 10.8 | 9.0 |
| Soluble Salts % by wt. | 3.0 max. | 1.0% |
| Surface Area (B.E.T.) | 100 to 800 m²/g (min.) | 400 |

A representative example of such an amorphous, hydrated, precipitated synthetic magnesium silicate having a surface area of at least 300 square meters per gram is available as Magnesol® Polysorb 30/40, a product of the Dallas Group of America, Inc., Whitehouse, N.J., and also is described in U.S. Pat. No. 4,681,768.

In another non-limiting embodiment, the magnesium silicate is a magnesium silicate which has a surface area of no more than 150 square meters per gram. In another non-limiting embodiment, the magnesium silicate has a surface area from about 50 square meters per gram to about 150 square meters per gram. In a non-limiting embodiment, such a magnesium silicate has a mole ratio of MgO to SiO₂ of from about 1:3.0 to about 1:3.8, and a pH (5% water suspension) of from about 9.5 to about 10.5. An example of such a magnesium silicate is available as Magnesol® HMR-LS, a product of the Dallas Group of America, Inc., Whitehouse, N.J.

In another non-limiting embodiment, the magnesium silicate is an amorphous, hydrous, precipitated synthetic magnesium silicate, which has a pH less than about 9.0. As used herein, the term “precipitated” means that the amorphous hydrated precipitated synthetic magnesium silicate is produced as a result of precipitation formed upon the contact of a magnesium salt and a source of silicate in an aqueous medium.

For purposes of the present invention, the pH of the magnesium silicate is the pH of the magnesium silicate as measured in a 5% slurry of the magnesium silicate in water. The pH of the magnesium silicate in a 5% slurry may be from about 8.2 to about 8.9, and more preferably from about 8.5 to about 8.8, and most preferably is about 8.5. Examples of such amorphous hydrous precipitated synthetic magnesium silicates are described in U.S. Pat. No. 5,006,356, and also are available as Magnesol® products such as Magnesol® R30, Magnesol® R60, and D-SOL® D60, products of the Dallas Group of America, Inc., Whitehouse, N.J. Magnesol® R30 has an average particle size of 30 microns, and Magnesol® R60 and D-SOL® D60 have an average particle size of 60 microns.

In a further non-limiting embodiment, the magnesium silicate has a pH (5% water suspension) of from about 9.0 to about 9.5. In another non-limiting embodiment, the magnesium silicate may be in the form of talc.

Representative examples of magnesium silicate which may be employed in accordance with the present invention also are described in U.S. Pat. Nos. 4,681,768; 5,006,356; 5,597,600; 6,312,598; 6,368,648; 6,482,386; 7,635,398; 9,295,810; and 10,563,150, the contents of which are incorporated herein by reference.

It is to be understood, however, that the scope of the present invention is not to be limited to any specific type of magnesium silicate or method for the production thereof.

In a non-limiting embodiment, the at least one adsorbent material has a water content of at least 5 wt. % to about 75 wt. %. In another non-limiting embodiment, the at least one adsorbent material has a water content of from about 10 wt. % to about 25 wt. %.

In a non-limiting embodiment, the holding portion of the container contains, in addition to the at least one purifying material, at least one antioxidant for the purposes of maintaining stability of the liquid to be purified. Such antioxidants include, but are not limited to, synthetic antioxidants, natural antioxidants, and combinations thereof. Suitable synthetic antioxidants include, but are not limited to, butylated hydroxytoluene (BHT), butylated hydroxyamide (BHA), propylgallate (PG), pyrogallol (PY), tert-butyl hydroquinone, 2, 5-ditert-butyl hydroquinone (TBHQ), or a tocopherol, and the like. Suitable natural antioxidants include, but are not limited to, ascorbic acid or salts thereof, carmosol acid, carmosol, carotene, citric acid, lethicin, green tea extracts, sage extracts, sesamol, spearmint extracts, rosemary extracts, and the like.

The at least one portion(s) that is designed to fail structurally upon heating of the liquid may be any of a variety of means that provide at least one opening in the container upon heating of the liquid into which the container is placed. Such means include, but are not limited to, at least one cap portion which detaches at least partially from the holding portion upon heating of the liquid into which the container is placed; at least one perforation in said container; at least one seam which is capable of opening upon heating of the liquid into which the container is placed; or at least one portion of the at least one wall portion having a thickness that is less than the thickness of the remainder of the at least one wall portion of the container, whereby such at least one portion of the at least one wall portion of the container having a thickness which is less than the thickness of the remainder of the at least one wall portion of the container provides at least one opening in the container upon heating of the liquid into which the container is placed.

In a non-limiting embodiment, the at least one portion that is designed to fail structurally upon heating of the liquid into which the container is placed is at least one cap portion.

In general, the container is formed from a material that permits the formation of at least one portion that is designed to fail structurally upon heating of the liquid in which the container is placed. As a result of the structural failure, each of the at least one portion(s) that is designed to fail structurally upon heating of the liquid provides at least one opening in the container. When the at least one portion that is designed to fail structurally upon heating of the liquid is at least one cap portion(s), the at least one cap portion(s) is detached at least partially from the holding portion of the container, thereby providing at least one opening in the container. In a non-limiting embodiment, the container is formed from polyethylene terephthalate, polyethylene, polypropylene, ethylene vinyl acetate (EVA), polycaprolactone (PCL), polyoxyethylene, polytetrafluoroethylene (PTFE), molded prep paper, filter paper, aluminum foil, agar-agar, or combinations thereof. In another non-limiting embodiment, the thickness(es) of the at least one wall portion(s), and any other portions of the holding portion is (are) greater than the thickness(es) of the at least one portion that opens, such as at least one cap portion(s).

The container may have a variety of shapes, including, but not limited to, spherical, hemispherical, oval, conical, frustoconical, pyramidal, cylindrical, box shapes (including quadrilateral-type box shapes such as cubical, rectangular, parallelogram, trapezoidal, rhomboid, triangular prism, pentagonal-shaped, hexagonal-shaped, heptagonal-shaped, octagonal-shaped, and the like), or in the form of intersecting rectangular prisms, such as a cross, for example. It is to be understood, however, that the scope of the present invention is not to be limited to any particular container shape.

In a non-limiting embodiment, the container includes a circular bottom panel. Extending upwardly and outwardly from the bottom panel is a conical wall that forms an obtuse angle with the bottom panel. The container has a cap which is connected detachably to a conical wall that extends downwardly and outwardly from the cap, and abuts the conical wall that extends upwardly and outwardly from the bottom panel.

Although the scope of the present invention is not to be limited to any theoretical reasoning, when the container containing the purifying agent, such as at least one adsorbent material, is placed in the liquid to be purified, such as used cooking oil, unrefined edible oil, biodiesel fuel, rendered fats, or a dielectric fluid, and the liquid is heated, there is an increase in pressure in the interior of the container. The increase in pressure in the interior of the container causes the at least one portion that is designed to fail structurally upon heating of the liquid, such as at least one cap portion, to provide at least one opening in the container, whereby the liquid enters the container and contacts the at least one purifying material. The at least one purifying material then is released from the container by gravity and/or pressure reduction and/or a venturi effect, through the at least one opening, whereby the at least one purifying material becomes dispersed through the liquid, and whereby the liquid is purified.

When the at least one portion that is designed to fail structurally upon heating of the liquid is at least one cap portion, the increase in pressure in the interior of the container, which results from heating the liquid, causes the at least one cap portion to be detached at least partially from the holding portion of the container, thereby providing at least one opening in the container, whereby the liquid contacts the at least one purifying material, and the at least one purifying material is released from the container as hereinabove described.

In one particular non-limiting embodiment, when the container contains a purifying agent which is a hydrous adsorbent powder, such as a hydrous magnesium silicate powder, the container is placed in the liquid to be purified, such as used cooking oil or an unrefined edible oil. The oil is heated to a temperature at which steam is released from the adsorbent powder. The steam causes an increase in pressure inside the container, which results in a designed structural failure, whereby the at least one portion that is designed to fail structurally upon heating of the liquid, such as the at least one cap portion, is detached at least partially from the holding portion of the container, thereby providing at least one opening in the container. The at least one opening provides a pressure release and contact of the oil with the adsorbent powder, and the powder is released from the container by gravity and/or pressure reduction and/or a venturi effect, whereby the adsorbent powder is dispersed throughout the oil and purifies the oil.

Thus, in accordance with another aspect of the present invention, there is provided a method of purifying a liquid. The method comprises contacting the liquid with a combination comprising a container comprising a holding portion having at least one wall portion, and at least one portion that is designed to fail structurally upon heating of the liquid and at least one purifying material contained in the holding portion of the container. The liquid to be purified then is heated to a temperature sufficient to effect at least one structural failure in the container, thereby providing at least one opening in the container, whereby the liquid is contacted with the at least one purifying material, and whereby the liquid is purified.

In a non-limiting embodiment, the at least one purifying material is at least one adsorbent material, which may be selected from those hereinabove described. In another non-limiting embodiment, the at least one adsorbent material comprises magnesium silicate.

In a non-limiting embodiment, the at least one adsorbent material has a water content of at least 5 wt. % to about 75 wt. %. In another non-limiting embodiment, the at least one adsorbent material has a water content of from about 10 wt. % to about 25 wt. %.

In a non-limiting embodiment, the liquid is heated to a temperature of at least 32° F. to about 500° F. In another non-limiting embodiment, the liquid is heated to a temperature of from about 100° F. to about 425° F.

In general, the at least one adsorbent material is present in an amount to provide effective purification of the liquid. In an non-limiting embodiment, the at least one adsorbent material is present in an amount of from about 0.1 wt. % to about 50 wt. %, based on the weight of the liquid. In another non-limiting embodiment, the at least one adsorbent material is present in an amount of from about 0.1 wt. % to about 10 wt. %, based on the weight of the liquid.

The liquid to be purified may be selected from those hereinabove described, including, but not limited to, used cooking oil, unrefined edible oil, biodiesel fuel, rendered fat, and dielectric fluids.

### BRIEF DESCRIPTION OF THE DRAWINGS

The invention now will be described with respect to the drawings, wherein:

FIG. 1 is a side view of a first non-limiting embodiment of a container employed in accordance with the present invention, showing the cap of the container in the closed position;

FIG. 2 is a cross-sectional view of the container of FIG. 1 showing the cap of the container in the open position;

FIG. 3 is a top perspective view of the container of FIG. 1;

FIG. 4 is a bottom perspective view of the container of FIG. 1;

FIG. 5 is a cross-sectional view of the container of FIG. 1 showing an adsorbent powder contained within;

FIG. 6 is a cross-sectional view of the container of FIGS. 1 and 5 placed in a fryer containing used cooking oil;

FIG. 7 is a cross-sectional view of the container of FIGS. 1, 5, and 6 placed in a fryer containing used cooking oil in which the cap of the container is in the open position;

FIG. 8 is a cross-sectional view of the container and fryer of FIG. 7 depicting the flow of used cooking oil into the container;

FIG. 9 is a cross-sectional view of the container and fryer of FIG. 7 depicting the flow of the adsorbent material out of the container and into the used cooking oil;

FIG. 10 is a side view of a second non-limiting embodiment of a container employed in accordance with the present invention, showing the cap of the container in the closed position;

FIG. 11 is a side view of the container of FIG. 10 showing the cap of the container in the open position;

FIG. 12 is a side view of a third non-limiting embodiment of a container employed in accordance with the present invention, showing the cap of the container in the closed position;

FIG. 13 is a side view of the container of FIG. 12 showing the cap of the container in the open positon;

FIG. 14 is a perspective view of a fourth non-limiting embodiment of a container employed in accordance with the present invention, wherein such container has four sealed edges and is closed;

FIG. 15 is a perspective view of the container of FIG. 14 when opened;

FIG. 16 is a perspective view of a fifth non-limiting embodiment of a container employed in accordance with the present invention, wherein said container has two sealed edges and is closed; and

FIG. 17 is a perspective view of the container of FIG. 16 when opened.

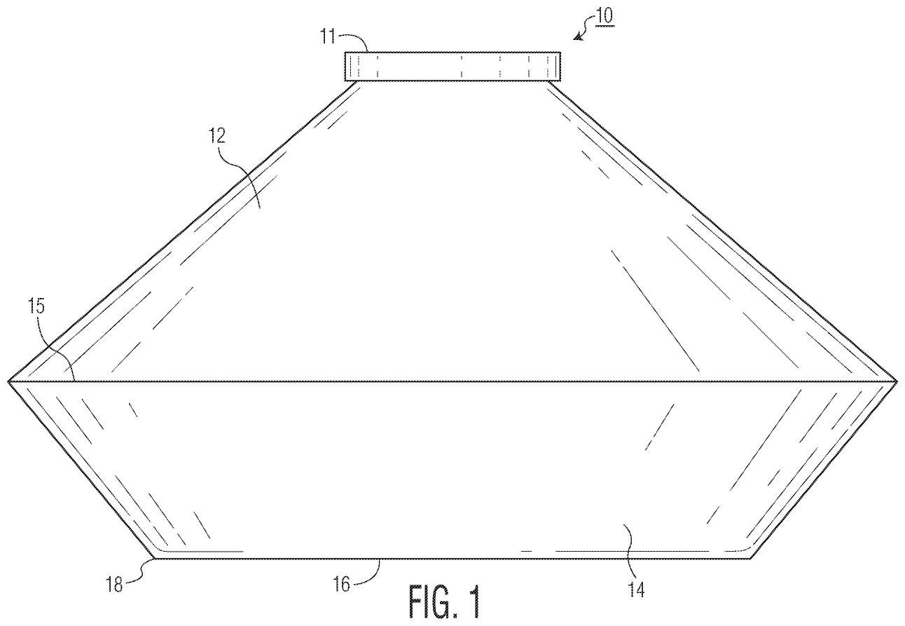

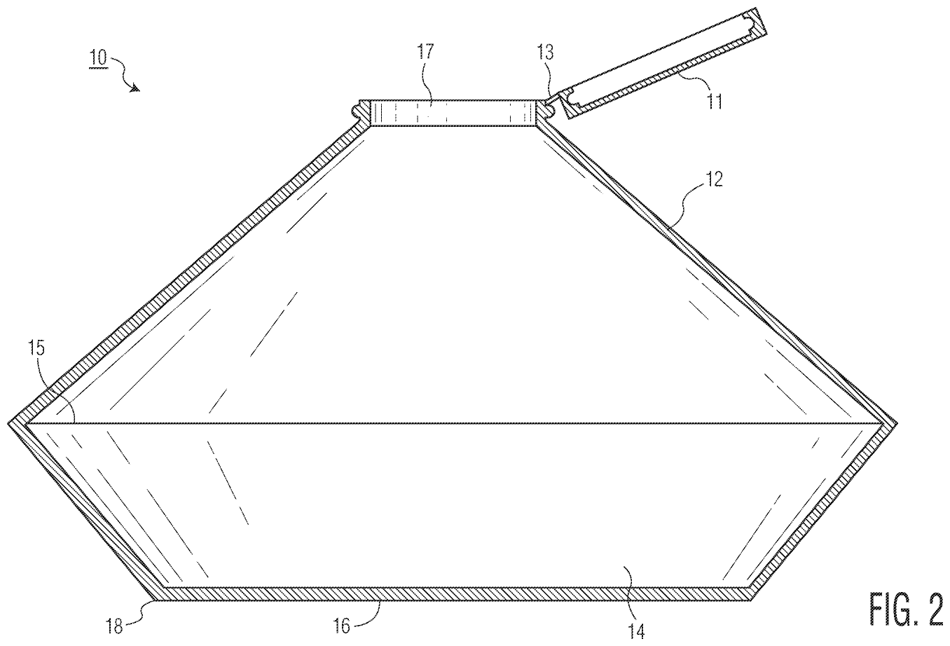

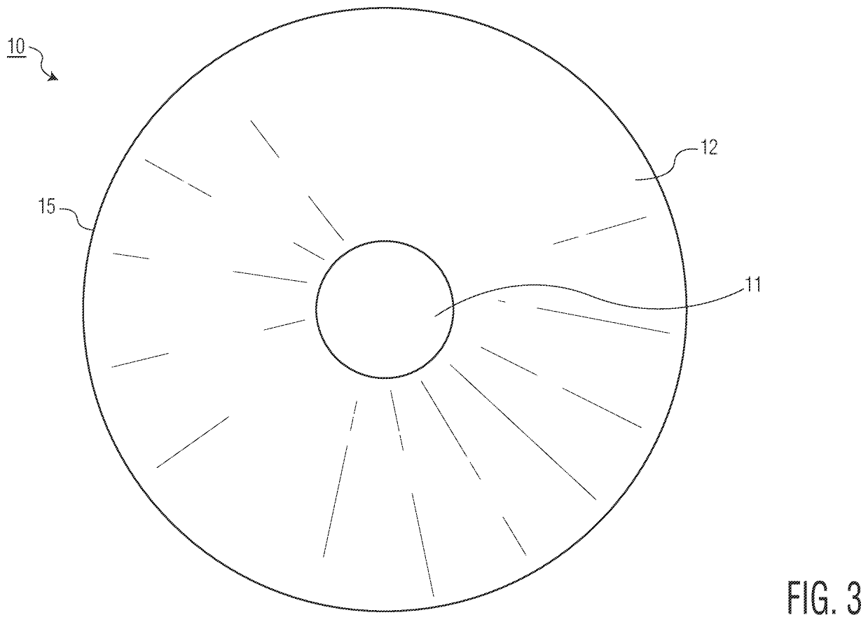

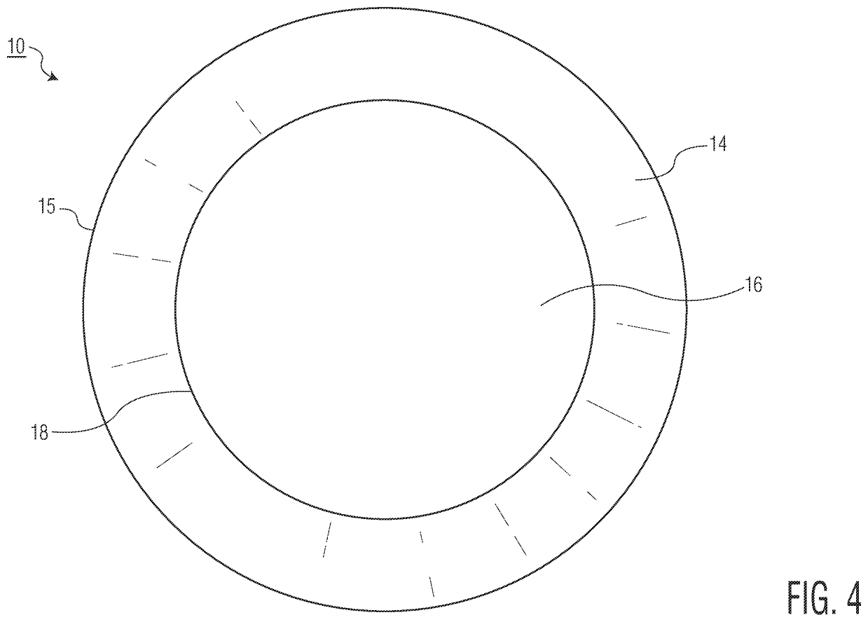

Referring now to the drawings, as shown in FIGS. 1 through 4, a non-limiting embodiment of the present invention includes a container 10 that includes a cap 11, which is connected by means of hinge 13 to opening 17. Container 10 also includes a downwardly extending upper conical wall 12, an upwardly extending lower conical wall 14, and a bottom panel 16. Upper conical wall 12 and lower conical wall 14 meet at seam 15, and lower conical wall 14 and bottom panel 16 meet at seam 18.

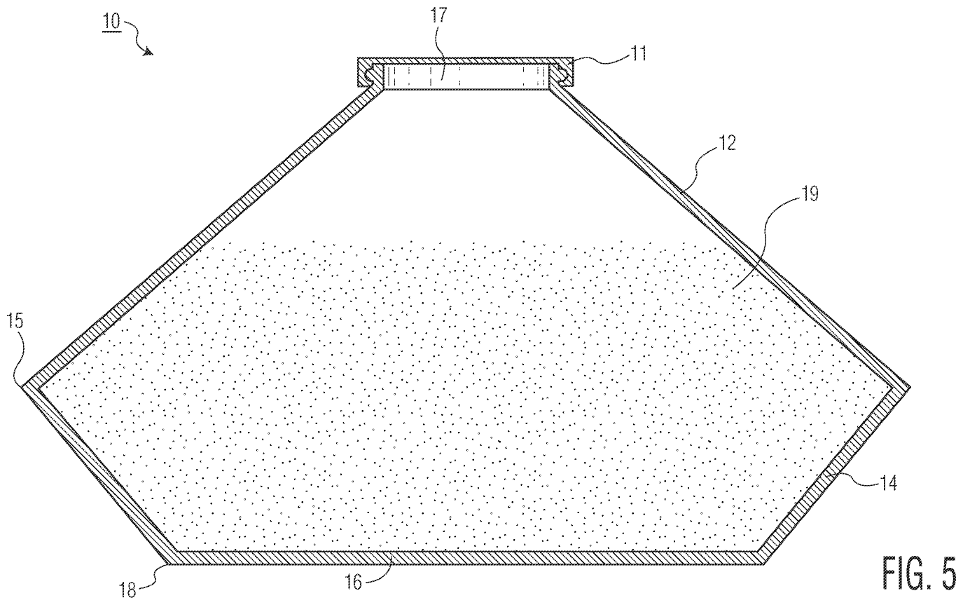

As shown in FIG. 5, container 10 in general contains a predetermined amount of a purifying material 19. Purifying material 19 may be a purifying powder that contains water. The purifying powder may be an adsorbent powder such as a hydrous magnesium silicate powder, i.e., a magnesium silicate powder that contains water.

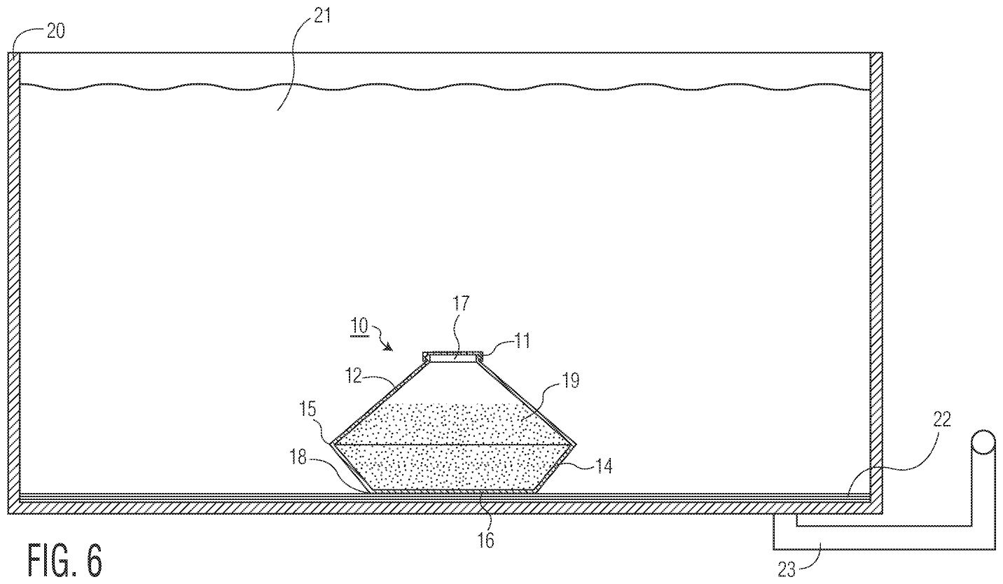

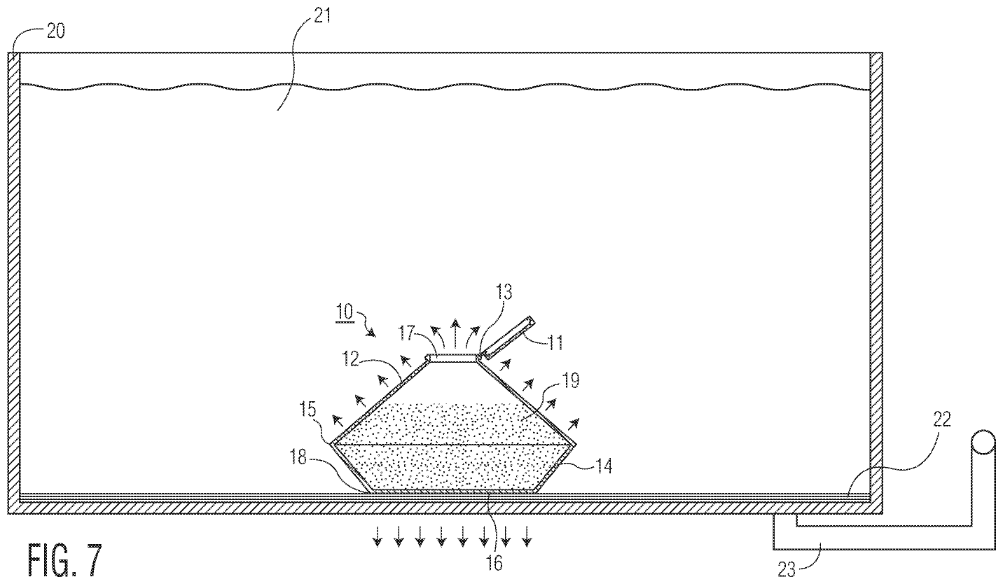

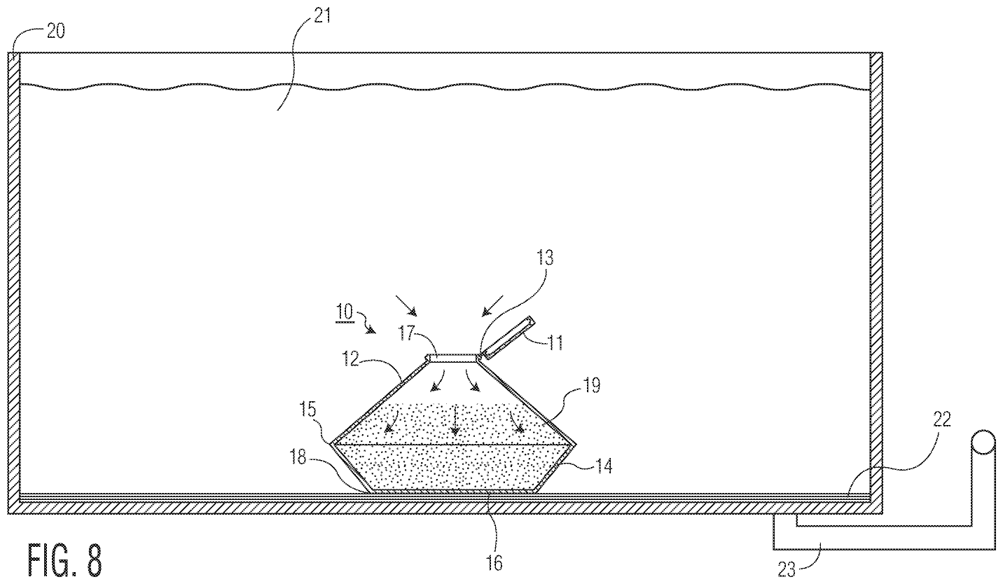

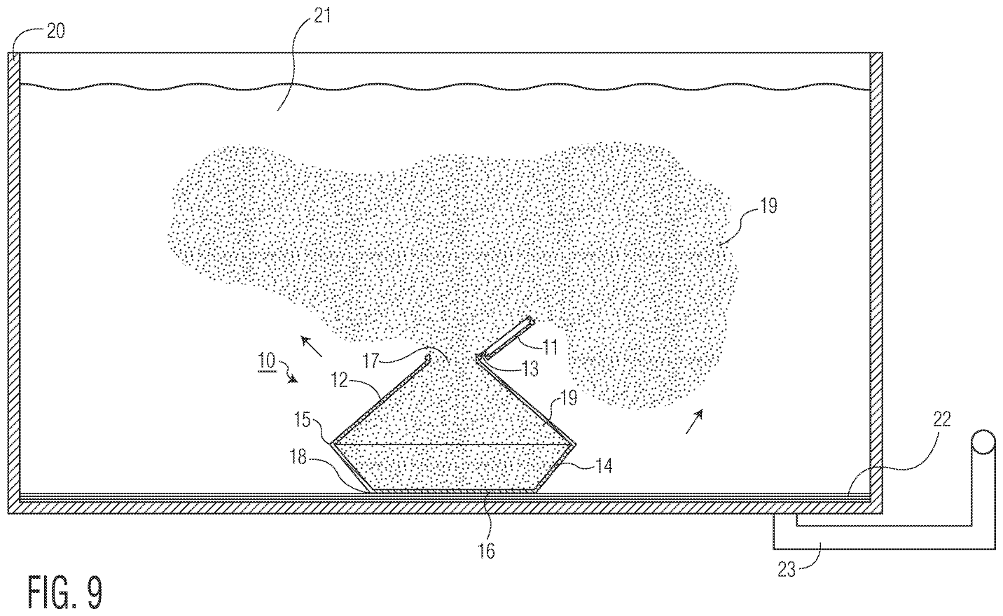

In general, container 10, which contains a purifying material 19, is placed into a liquid, such as used cooking oil, unrefined edible oil, biodiesel fuel, or a dielectric fluid, that is to be purified by the purifying material. For example, as shown in FIGS. 6 through 9, container 10, which contains purifying material 19, is placed in a vat or fryer 20 that contains hot used cooking oil 21 and a filter means 22. The hot used cooking oil heats container 10 and the purifying material 19, which may be a hydrous adsorbent magnesium silicate powder, contained inside. As the purifying material contained inside container 10 is heated, the water contained in purifying material 19 is released from purifying material 19 as steam, whereby there is an increase in gas pressure inside container 10. As the gas pressure inside container 10 increases, cap 11 is forced open, whereby the hot used cooking oil 21 enters container 10 through opening 17, and the hot used cooking oil 21 contacts purifying material 19. Purifying material 19 also exits container 10 through opening 17, and is dispersed throughout the hot used cooking oil 21. As the purifying material 19 is dispersed throughout the used cooking oil 21, the purifying material removes impurities from the used cooking oil 21, including but not limited to, free fatty acids and oxidized fatty acids.

Purifying material 19 remains in contact with the hot used cooking oil 21 for a time sufficient to effect a satisfactory removal of the impurities from used cooking oil 21. After the impurities have been removed from used cooking oil 21, the purifying material 19 is separated from used cooking oil 21 by passing the used cooking oil through filter 22, whereby filter 22 retains the purifying material 19, but allows the used cooking oil 21 to pass through filter 22 and into pipe 23, through which the purified oil is recycled to the vat or fryer 20 by means known to those skilled in the art. Filter 22 may be any means for filtering used cooking oil known to those skilled in the art, such as filter screens, filter grids, filter pads, filter papers, filter envelopes, and combinations thereof. In a non-limiting embodiment, when filter 22 includes a filter pad and/or a filter paper, or a filter envelope, the filter pad, filter paper, or filter envelope also may be impregnated with the purifying material to provide further removal of impurities from the used cooking oil.

After the used cooking oil 21 has passed through filter 22 and into pipe 23, container 10 may be removed from fryer 20, and be cleaned and reused, and refilled with a predetermined amount of purifying material 19. Alternatively, container 10 may be discarded.

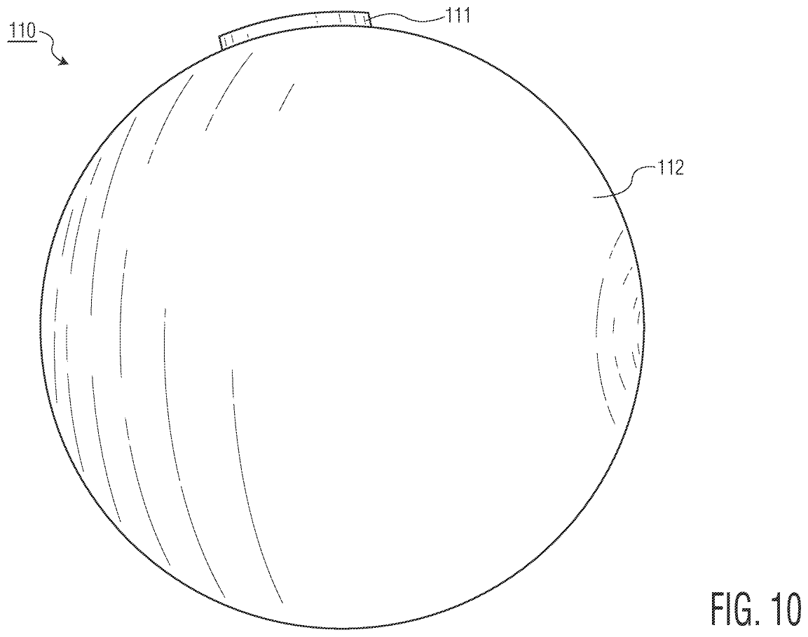

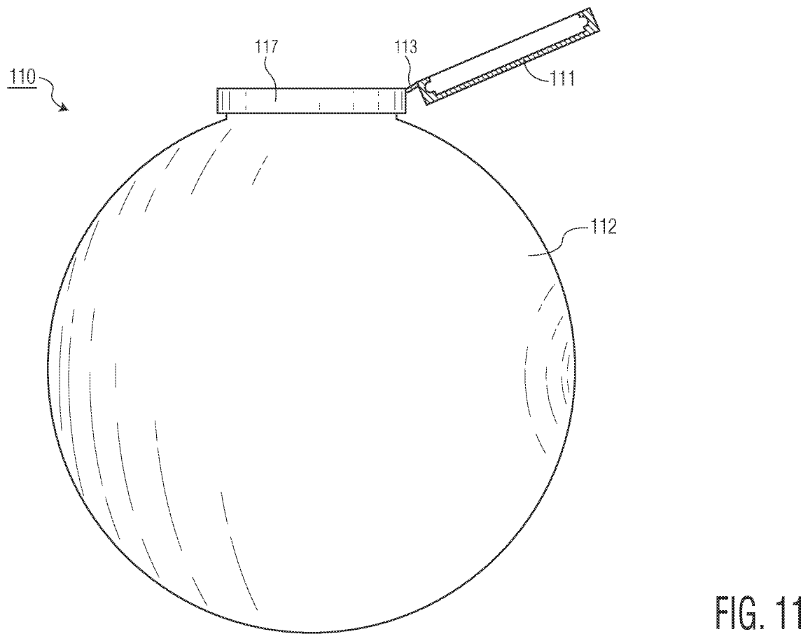

FIGS. 10 and 11 depict a second non-limiting embodiment of a container 110 that includes a sphere 112, having an opening 117, a cap 111, and a hinge 113 that connects cap 111 to opening 117.

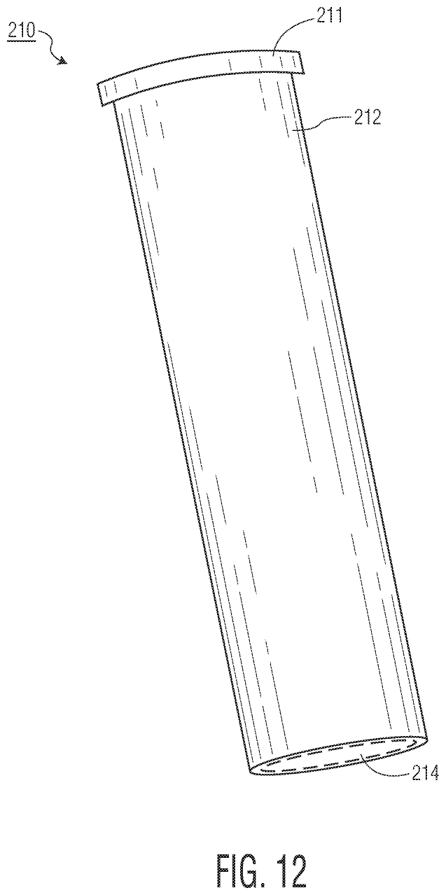

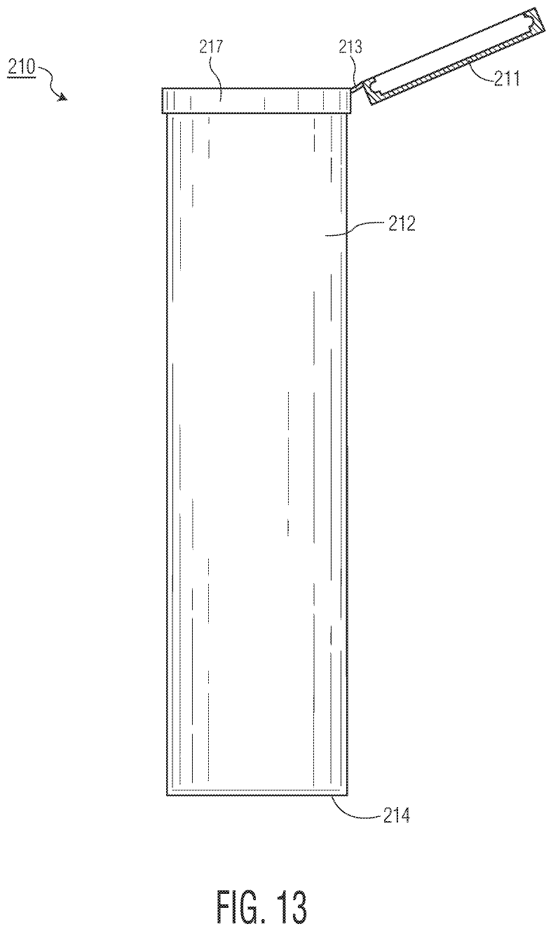

FIGS. 12 and 13 depict a third non-limiting embodiment of a container 210 that includes a cap 211, a cylindrical wall 212, a bottom panel 214, and an opening 217. Cap 211 is connected to opening 217 by means of hinge 213.

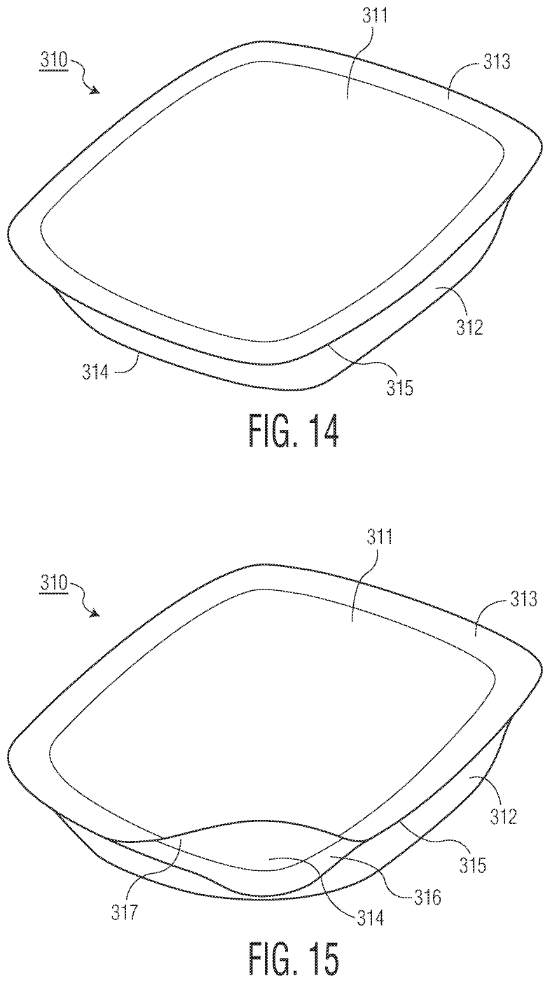

FIGS. 14 and 15 depict a fourth non-limiting embodiment of a container 310, which may be made of foil, or filter paper, having a top panel 311 having a peripheral edge 313, side walls referred to collectively as 312, a bottom panel 314, and a flange 316 extended outwardly from the top of side walls 312. Peripheral edge 313 is sealed to flange 316 to form a seam 315. The sealing of edge 313 to flange 316 may be accomplished by means known to those skilled in the art, such as, for example, heat sealing and/or sealing with at least one adhesive.

Container 310 contains a predetermined amount of at least one purifying material. When container 310 is placed in a liquid to be purified, and the liquid is heated, the seal of edge 313 to flange 316 along seam 315 is broken, and edge 313 separates from flange 316, thus forming an opening 317, through which the liquid to be purified enters container 310 and the at least one purifying material exits container 310, whereby the at least one purifying material contacts and purifies the liquid to be purified.

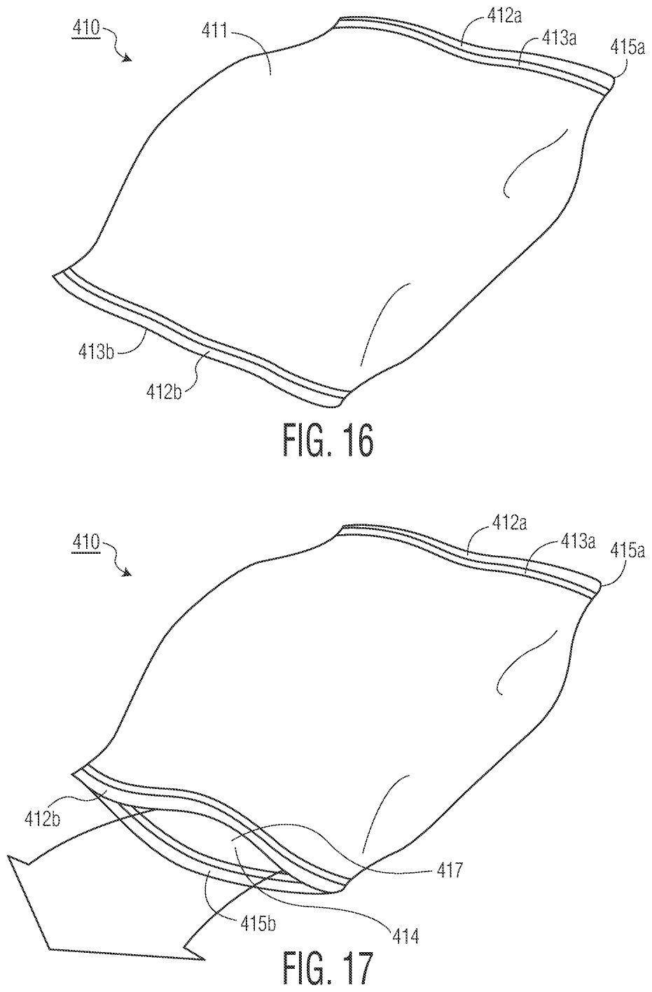

FIGS. 16 and 17 depict a fifth non-limiting embodiment of a container 410, which may be made of a thermoplastic polymer, having a top panel 411 having edge portions 412a and 412b, and a bottom panel 414 having edge portions 415a and 415b. Edge portion 412a is sealed to edge portion 415a along seam 413a, and edge portion 412b is sealed to edge portion 415b along seam 413b. Such sealing may be accomplished by means known to those skilled in the art, such as, for example, heat sealing and/or sealing with at least one adhesive.

Container 410 contains a predetermined amount of at least one purifying material. When container 410 is placed in a liquid to be purified, and the liquid is heated, at least one of the seals of edge 412a to edge 415a along seam 413a and of edge 412b to edge 415b along seam 413b is broken, and edge 412a separates from edge 415a and/or edge 412b separates from edge 415b, thus forming at least one opening 417, through which the liquid to be purified enters container 410 and the at least one purifying material exits container 410, whereby the at least one purifying material contacts the liquid to be purified and purifies the liquid to be purified.

The disclosures of all patents and publications are incorporated herein by reference to the same extent as if each patent or publication were incorporated individually by reference.

It is to be understood, however, that the scope of the present invention is not to be limited to the specific embodiments described above. The invention may be practiced other than as particularly described and still be within the scope of the accompanying claims.

What is claimed is:

1. A combination for purifying a liquid, comprising:
a container comprising a holding portion having at least one wall portion, and at least one portion that is designed to fail structurally upon heating of the liquid; and
at least one purifying material contained in said holding portion of said container, wherein, upon contact of said container with said liquid, and heating of said liquid, at least one of said at least one portions(s) that is designed to fail structurally provides at least one opening in said container, whereby said liquid is contacted by said at least one purifying material, and whereby said liquid is purified.

2. The combination of claim 1 wherein said at least one purifying material is at least one adsorbent material.

3. The combination of claim 2 wherein said at least one adsorbent material is selected from the group consisting of magnesium silicate, magnesium aluminum silicate, calcium silicate, sodium silicates, activated carbon, silica gel, magnesium phosphate, metal hydroxides, metal oxides, metal carbonates, sodium sesquicarbonate, metal silicates, bleaching clays, bleaching earths, bentonite clay, alumina, and mixtures thereof.

4. The combination of claim 3 wherein said at least one adsorbent material comprises magnesium silicate.

5. The combination of claim 2 wherein said at least one adsorbent material has a water content of at least 5 wt. % to about 75 wt. %.

6. The combination of claim 5 wherein said at least one adsorbent material has a water content of from about 10 wt. % to about 25 wt. %.

7. The combination of claim 1 wherein said at least one portion that is designed to fail structurally is at least one cap portion.

8. A method of purifying a liquid, comprising:
contacting said liquid with a combination comprising a container comprising a holding portion having at least one wall portion, and at least one portion that is designed to fail structurally upon heating of the liquid and at least one purifying material contained in said holding portion of said container; and
heating said liquid to be purified to a temperature sufficient to effect at least one structural failure in said container, thereby providing at least one opening in said container, whereby said liquid is contacted by said at least one purifying material, and whereby said liquid is purified.

9. The method of claim 8 wherein said at least one purifying material is at least one adsorbent material.

10. The method of claim 9 wherein said at least one adsorbent material is selected from the group consisting of magnesium silicate, magnesium aluminum silicate, calcium silicate, sodium silicates, activated carbon, silica gel, magnesium phosphate, metal hydroxides, metal oxides, metal carbonates, sodium sesquicarbonate, metal silicates, bleaching clays, bleaching earths, bentonite clay, alumina, and mixtures thereof.

11. The method of claim 10 wherein said at least one adsorbent material comprises magnesium silicate.

12. The method of claim 9 wherein said at least one adsorbent material has a water content of at least 5 wt. % to about 75 wt. %.

13. The method of claim 12 wherein said at least one adsorbent material has a water content of from about 10 wt. % to about 25 wt. %.

14. The method of claim 8 wherein said at least one portion that is designed to fail structurally upon heating of the liquid is at least one cap portion.

15. The method of claim 8 wherein said liquid is heated to a temperature of at least 32° F. to about 500° F.

16. The method of claim 15 wherein said liquid is heated to a temperature of from about 100° F. to about 425° F.

17. The method of claim 8 wherein said at least one adsorbent material is present in an amount of from about 0.1 wt. % to about 50 wt. %, based on the weight of said liquid.

18. The method of claim 17 wherein said at least one adsorbent material is present in an amount of from about 0.1 wt. % to about 10 wt. %, based on the weight of said liquid.

19. The method of claim 8 wherein said liquid is used cooking oil.

20. The method of claim 8 wherein said liquid is an unrefined edible oil.

21. The method of claim 8 wherein said liquid is biodiesel fuel.

22. The method of claim 8 wherein said liquid is a dielectric fluid.

23. The method of claim 8 wherein said liquid is a rendered fat.
